(19) United States
(12) Patent Application Publication
(10) Pub. No.: US 2020/0327094 A1
(43) Pub. Date: Oct. 15, 2020

(54) Method, System and Apparatus for Enhancing Efficiency of Main Processor(s) in a System on Chip

(71) Applicant: Guruprasad Putty Vadirajan, Bangalore (IN)

(72) Inventor: Guruprasad Putty Vadirajan, Bangalore (IN)

(21) Appl. No.: 16/458,584

(22) Filed: Jul. 1, 2019

(30) Foreign Application Priority Data
Apr. 15, 2019 (IN) 201941015147

(51) Int. Cl. G06F 15/78

(52) U.S. Cl. CPC G06F 15/7821

(57) ABSTRACT

A System on Chip (SoC) (101) comprising a set of processors (110) providing processing power in the SoC, a network interconnect (NIC) (120) coupling the set of processors (110) to a set of devices (130) over a set of buses (140), in that, the NIC (120) comprising a set of master nodes connected to the set of buses (140) and a set of slave nodes dispersed on the set of devices (130) connected set of buses, for connectivity between the NIC (120) and set of devices (130), and an intelligent auxiliary unit (IAU) (150) comprising a second set of master nodes coupled to the set of buses (140), wherein the IAU (150) is configured to perform a first set of operations on the set of devices (130) without accessing the NIC (120) otherwise required to be performed by the set of processors (110) through NIC (120), thereby allowing the set of processors (110) to execute more complex computation.

### BACKGROUND

### CROSS REFERENCES TO RELATED APPLICATIONS

This application claims priority from Indian patent application No. 201941015147 filed on Apr. 15, 2019 which is incorporated herein in its entirety by reference.

### TECHNICAL FIELD

Embodiments of the present disclosure relate generally to electronic system and more specifically to method, system and apparatus for enhancing efficiency of main processor(s) in a system on chip.

### RELATED ART

System on Chip (SoC) often refers to a general purpose or functional specific computer system formed on a semiconductor substrate and made available as an integrated circuit or as a single chip. The SoC comprises processors, peripheral devices, memory, registers, interconnects, and other functional electronic elements like co-processors, dynamic memory access controller (DMA), network interface controller or interconnects (NIC), network on chip (NOC), and cache coherent network (CCN—also generally referred as intelligent NIC that perform some of the operations without processor requiring to monitor) as is well known in the art. The elements of the conventional SoC is more fully described in a book titled “ARM System-on-Chip Architecture” published by “Steve Furber” which is incorporated herein in its entirety by reference.

In the SoC, the processors are connected to the peripherals and other elements to form the computer system through NIC and/or CCN. However, the processors efficiency is not fully utilised at least when processor is made to wait (idle) for a response form a peripheral, perform routine data transfer operations, and other regular operations. While, in some conventional computer systems, a co-processor and functional specific processor are introduced along with a main processor to enhance the utility of the main processor, such system still operate at a lesser efficiency as the peripherals are still connected through the same NIC/CCN thus not giving much advantage. In other words, in the conventional SOC, a number of processors (including co-processors, DMA etc.,) are connected to peripherals (including number of memory units, registers, etc.,) through common NIC and/or CCN, thus exhibits limitation in terms of exploiting a higher efficiency of the processors.

### SUMMARY

A System on Chip (SoC) (101) comprising a set of processors (110) providing processing power in the SoC, a network interconnect (NIC) (120) coupling the set of processors (110) to a set of devices (130) over a set of buses (140), in that, the NIC (120) comprising a set of master nodes connected to the set of buses (140) and a set of slave nodes dispersed on the set of devices (130) connected set of buses, for connectivity between the NIC (120) and set of devices (130), and an intelligent auxiliary unit (IAU) (150) comprising a second set of master nodes coupled to the set of buses (140), wherein the IAU (150) is configured to perform a first set of operations on the set of devices (130) without accessing the NIC (120) otherwise required to be performed by the set of processors (110) through NIC (120), thereby allowing the set of processors (110) to execute more complex computation.

Several aspects are described below, with reference to diagrams. It should be understood that numerous specific details, relationships, and methods are set forth to provide a full understanding of the present disclosure. One who skilled in the relevant art, however, will readily recognize that the present disclosure can be practiced without one or more of the specific details, or with other methods, etc. In other instances, well-known structures or operations are not shown in detail to avoid obscuring the features of the present disclosure.

### BRIEF DESCRIPTION OF DRAWINGS

FIG. 1 is a block diagram of a system on chip (SoC) in an embodiment of the present disclosure.

FIG. 2 is block diagram illustrating the manner in which IAU may be deployed between NIC and the peripherals in an embodiment.

FIG. 3A is block diagram illustrating the operations of a processors in a conventional SoC.

FIG. 3B is block diagram illustrating the operations of processors 205 and IAU 250 in an embodiment.

FIG. 4 is a block diagram of an internal memory of IAU 250 in an embodiment illustrating an example coherence/synchronization between the processor 205 and IAU 250.

FIG. 5 is an example finite state machine (FSM) illustrating the manner in which IAU 250 may operate in an embodiment.

### DETAILED DESCRIPTION OF THE PREFERRED EXAMPLES

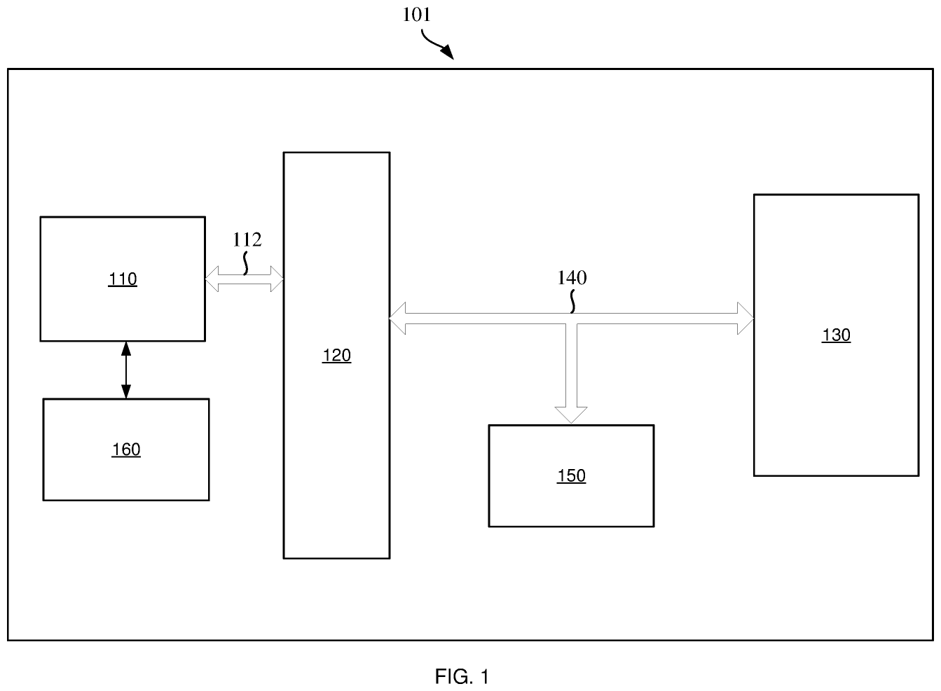

FIG. 1 is a block diagram of a system on chip (SoC) in an embodiment of the present disclosure. The SoC 101 is shown comprising processor 110, NIC 120, peripherals 130, Interconnects 140, intelligent auxiliary unit (IAU) 150 and instruction set 160. Each element is described in further detail below.

The processor 110 providing digital processing power to the SoC, in that, the processor may execute set of instructions in the instruction set 160 to perform desired operations such as but not limited, fetch data, transfer data, perform computation, logical and arithmetic operations, complex data processing, image processing, system control operations and other operations generally referred to the term processor in the art. The processor 110 may comprise combination of one are more processors, multi core processor, multiple processors connected in parallel, multiple processors connected in series, sub processors, co-processors, DMA etc. The Processor 110 is connected to the NIC 120 on a dedicated connection line(s) 112.

The NIC 120 facilitates connection between peripheral 130 to the processor 110 on one or more interconnects 140. The NIC 120 may operate as switch to connect desired one of the interconnect 140 to the dedicated line 112 so as to enable the processor 110 to interact with the corresponding one of the peripheral 130. For example, when a processor 110 requires establishing connection between peripheral 130, the NIC 120 may connect the processor 110 (path 112) to the interconnect 140.

The peripheral 130 is an electronic unit enhancing the system functionality in one or more ways and may perform dedicated operations controlled by the processor 110. The peripheral 130 comprise one or more memory units, storage units, registered, timers, input/output (I/O) devices, other network link controller etc.

The interconnects 140 are communication paths (often referred to bus) operative to transfer data employing one or more communication protocol. The interconnects 140 are often referred to by the protocols and bus architecture. The interconnects 140 may comprise AMBA bus, address bus, Data bus, USB, SATA, AXI4, APB, etc., each term assuming the respective bus name established in the art.

The intelligent auxiliary unit (IAU) 150 preforms, controls, monitors and manages the data transfer, operations, status, of the peripherals in accordance with the objectives set forth by the processor 110. In one embodiment, the IAU 150 connects peripherals 130 without connecting to NIC 120. In other words, the IAU 150 connects to interconnect 140 as and when needed to manage desired one or more peripheral device 130 without NIC. As a result, the SoC 101 utilizes the processor 110 in performing more complex and intensive computations with substantially reduced idle time to provide overall enhanced processor efficiency. The manner in which the IAU 150 in the SoC 101 may be deployed in an embodiment is further descried below.

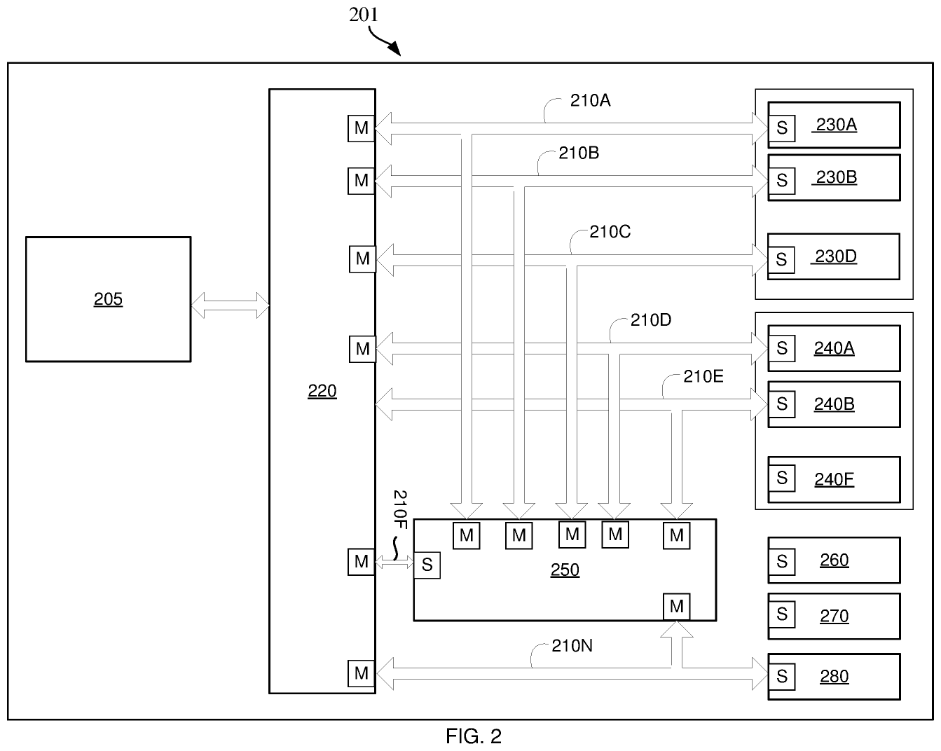

FIG. 2 is block diagram illustrating the manner in which IAU may be deployed between NIC and the peripherals in an embodiment. The block diagram is shown comprising processor 205, buses 210A-210N, NIC 220, memory 230A-230D, general purpose I/O (GpIO) 240A-240F, IAU 250, peripherals 260, network links 270 and registers 280. Each element is described in further detail below.

The buses 210A-210N operate on a protocol to transmit and receive (transfer) data between the components connected to it. The employed bus protocol may operate in the master and slave configuration in that, master control the bus access while slave receive or transfer data as per the instructions received from the master. Further, the buses 210A-210N may employ several handshakes signaling for reliable data transfer. In one embodiment buses 210A-210N represents plurality of AXI4 buses, APB buses for example.

The NIC 220 receives instruction to connect/couple the buses 210A-210N to the processor 205 (operative similar to processor 110). The NIC 220 is further shown comprising interface nodes represented by letter “M”. Each node comprises electronics and memory with protocol stacks implementing physical layer, datalink layer and other signal level translation circuitry to meet the bus interface requirement. In one embodiment, the nodes M are operative as Master nodes, thus controlling the data on the buses 210A-210N. The NIC 220 may be implemented with some processing power to handle signaling and to implement protocol stack. Further, the NIC 220 may also comprise buffer storage for temporary storage of data to be transferred or on reception.

The memory 230A-230D stores data. The data stored are for processing by the processor, result of processing, storage, instructions, configuration data, protocol stacks, system information, data received from external devices, temporary storage, intermediate results, for example. The memory 230A-230D may be devices such as ROM (read only memory), RAM (random access memory), flash memory, magnetic disc, optical disc, etc. Each memory 230A-230D may be accessible over one or more bus types. Accordingly, the memory 230A-230D further shown comprising interface nodes represented by letter ‘S’ that are slave in nature and controllable by the corresponding masters. In one embodiment one or more memory 230A-230D may be accessible through memory controllers that are connected to the bus 210A-210N.

The general purpose I/Os (GpIO) 240A-240F are configurable input or output ports to receive or send data to external device. Accordingly, the connectivity is programmed or established based on the device connected to the port. The peripherals 260 are devices that form part of the SoC to provide over all functionality. The peripherals 260 may comprise sensors, wireless transceivers, etc.

The registers 280 hold binary data in bits for quick reference. The small sequence of bits is loaded on to the registers to indicate an action, status of action, role, etc., so that the value stored in the registers 280 are read by different elements/blocks of the SOC. Further, the registers 280 are also used for temporary storage to store the intermediate computation values. Further, the registers 280 operate as data passage between one element and another element in the SOC. The network links 270 are the other downstream NIC's which extends SoC capability by adding more devices to SoC, Thus, extending compatibility of interconnection to special devices that are connected on network protocol not required for operation of SoC. The I/Os (GpIO) 240A-240F, peripherals 260, network links 270 and registers 280 are also shown with nodes ‘S’

The IAU 250 performs operations that are executable without engaging processor 205 in the SoC. In one embodiment, the IAU 250, perform operations between the memories 230A-230D, perform monitoring signals to/from the peripherals 260, data transfer from peripheral 260 to memory 230A-230D and vice-a-versa, for example. In an embodiment the IAU 250 performs operations on the device connected to the NIC 220 on the buses 210A-210D without processor 205 requiring to issue any instruction to the NIC 220 to perform such action. Thus, to that extent the processor is freed to perform other computation intense and complex tasks thereby enhancing processor efficiency.

Accordingly, the IAU is shown comprising nodes represented as ‘M’ and ‘S’ comprising electronics and memory with protocol stacks implementing physical layer, datalink layer and other signal level translation circuitry to meeting the bus interface requirement. In one embodiment, the nodes M are operative as master nodes, and S are operative as slave nodes, thus controlling the data on the buses 210A-210N similar to the M nodes of the NIC 220. In one embodiment, the master interface nodes are implemented with AXI4 bus interface, the frequency of AXI4 bus clock is set to be the same as AXI4 master clock. This can be configured during building of RTL code. Further some of the master nodes may also be set to APB4 master interface and the clock frequency is same as NIC master APB4 clock. This can also be configured during Build time. One of the IAU nodes (255F) is set to APB4 slave. This interface is used for programming some of IAU 250 Registers. The manner in which the efficiency of the processor may be enhanced with desired functionality of the SoC is described in further detail below.

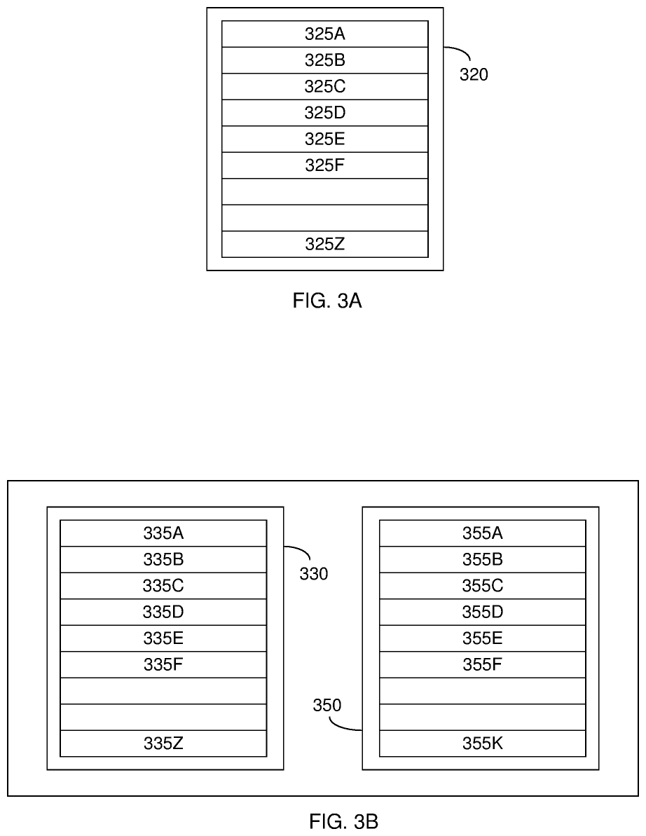

FIG. 3A is block diagram illustrating the operations of a processor in a conventional SoC. In that the instruction set 320 is shown comprising instructions 325A-325Z. Each instruction set 325A-325Z performs correlated, control, computational and/or data processing functionalities for example. In that, as an example, the instructions 325B through instruction 325E perform data transfer between two memory units. The instruction 325B initializes the NIC for data transfer, instructions 325C-325D executes the data transfer between the memory unit by applying protocol read, write, acknowledgement, wait etc. operations, and the instruction 325E terminates/release the NIC.

In contrast, in the SoC 201 with the IAU 250 the processor 205 is freed for substantial set of instructions to perform other more complex operation as described below.

FIG. 3B is block diagram illustrating the operations of processors 205 and IAU 250 in an embodiment. The block diagram is shown comprising the processor instructions set 330 and the IAU instruction set 350. The blocks 330 and 350 are described in conjunction with blocks of FIG. 2 merely for ease of understanding without loss of any generality.

The instructions set of the processor 330 are an example set of instructions, the processor executes to provide the desired functionality in the SoC. The instruction set 330 is shown comprising instructions 335A-335Z. Each instructions 335A-335Z performs correlated, control, computational and/or data processing functionalities for example. In that, as an example, the instructions 335B is an opcode to the IAU 250 and the instruction 335E to execute when an interrupt from IAU 250 is received, thereby leaving executable space 335C-335D free to the processor.

The instruction set of IAU 350 is shown comprising instructions 355A-355K. The 355A-E perform data transfer from memory 230B to 230C. In that, the instruction 355A, opcode for IAU to perform necessary action, the instruction 355B-355C executes the data transfer from the memory 230B to 230C on the buses without involving NIC 220 and by applying protocol read, write, acknowledgement, wait etc., and the instruction 355D sends an interrupt to processor 205 indicating the completion of the data transfer. Thus, during the execution of the data transfer between the memory by the IAU 250, both processor 205 and NIC 220 are rendered free (335C-335D) to engage, other peripherals, perform more complex operations etc. Thus, enhancing the efficiency of the SoC. It may be appreciated that, instructions 330 represents the operations that needs to be performed for providing the intended functionality the SoC and also, the time and power taken by the processor to execute the instructions. Accordingly, when the processor is freed from executing the instructions 335C-335D (330), the same space (processor time and power) may be utilized to perform other complex tasks.

As may be further appreciated, the processor 110 and 205 in the SOC 101 and 201 are built with complex logical circuits (say for example with large computational units, registers) to perform complex and high-speed operations to handle complex NICs. While such processor built with high processing power is cause of inefficiency at least when employed for routine operations and made to wait for a response. The embodiments of the present disclosure overcome such inefficiency when IAU 250 performs routine and wait for response operations without NIC interface and further in synchronization with the processor 205. The manner in which the Processor 205 and IAU 250 operate in the SOC 201 is described in further detail below.

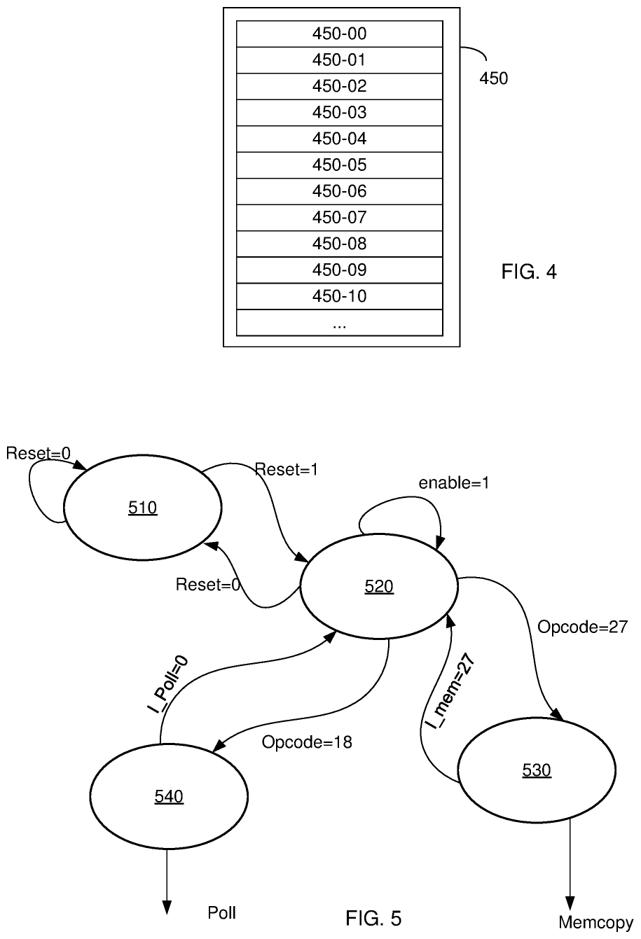

FIG. 4 is a block diagram of an internal memory of IAU 250 in an embodiment illustrating an example coherence/synchronization between the processor 205 and IAU 250. The memory 410 is shown comprising address offsets 450-00 through 450-10 for illustration. In that, 450-00 is for opcode, 450-01 is for source memory address, 450-02 is for destination memory address, 450-03 is for size, 450-04 specifies the address of the register that need to be polled, 450-05 specifies the data that need to be compared, for example.

In operation, IAU 250 keeps polling its internal memory location (base address, for example). When the value in this location changes to Non-Zero value, it identifies the operation that needs to be performed. For example, the base address to be polled may be 450-00. When the value is 27 at the 450-00 (representing “memcopy”), IAU 250 performs memory copy operation by obtaining source address, destination address and size 450-01, 450-02, and 450-03. When IAU is executing memcopy operation, it may also perform polling of registers at the same time. This is to say that two independent operations are performed parallelly as the bus or interconnect used for these operations are independent. This drastically increases the performance of SoC.

The memory copy operations may be performed between two memory blocks connected to two different AXI bus. It can be between DDR/HBM to SRAM vice versa or it can also between two memory regions in the SRAM/DDR/HBM (for example). In the latter case, the transfer may be performed on only one AXI4 bus as the memory range come under a hardware block. When memory copy operation is complete, IAU 250 generates an interrupt to the processor 205 (I_mem) to indicate completion of the memory copy.

Similarly, when the opcode is 18 then IAU 250 performs polling of registers. The register address and the value to be polled is mentioned in memory offset 450-4 and 450-5. IAU 250 then would start reading the APB4 interface. It compares the data sent by the peripheral with the value written in memory offset 450-05. When the value matches, IAU 250 gives an interrupt (I_POLL) to processor 205 else continues to read till both the value matches.

Similarly, when the opcode value is 180, then IAU 250 reads from source memory address located at offset 450-06 a number of bytes specified at offset 450-07 and stores it in internal memory. Subsequently, when the processor 205 requests these data it can be read from IAU 250 internal memory rather than from main memory connected to NIC 220 (like DDR, SRAM etc.) as this saves lot of time as time to read from DDR is more when compared to reading from the memory.

As may be appreciated, in the conventional SoC, a significant bandwidth of processor is spent on polling of some registers or doing memory to memory copy as against employing IAU 250. In the present disclosure processor 205 would be able to do other task in the same time. Further, In the embodiments described above, when the IAU 250 is polling, Processor 205 may use memory channel for reading etc. If this was not the case, processor has to first complete the polling then move to read the data from memory. This causes significant waste of time. This is also because processor executes instruction sequentially and polling instruction can block the read instruction. Further, in case of memory copy, processor 205 may inform IAU 250 to do memory copy and it can perform other operations like reading stream of data from other sources or writing to peripherals in configuration space. If this was not the case, then processor has to do memory copy and the read the stream of data. This considerably reduces the system performance.

Further, it may be appreciated that, when processor performs the polling, data flow is from Processor→NIC→APB bridge→peripheral. Similarly, the response/data goes from Peripheral→APB bridge→NIC→Processor. Also, when processor reads the data and if it does not match, it again sends the read request with the whole sequence of accessing and this process repeats. However, with IAU 250, request starts from IAU→peripheral and response from Peripheral→IAU and thereby allowing use of processor 205 more effectively.

Though, the operations of IAU 250 is described with respect to example memory copy, polling etc., the IAU 250 may be employed to other operation on the buses 210A-210N or peripheral connected to the buses 210A-210N such as but not limited to monitor data transactions on all the buses, monitor frequently accessed channel and assign high priority to the channel, cycles wasted for waiting/polling for each polling instance and number of times polling has been called, number of times memcopy task is executed, frequently accessed memory range, to initialize memory with zero's or any other value as processors requires, make peripherals to operate in low power or low frequency mode by turning off clock or disabling the peripherals, for example.

In one embodiment, IAU 250 may generate interrupts to indicate various status. As an example, in one embodiment, IAU 250 generates interrupts I_poll when polling of register is complete i.e data in the peripheral register matches with the expected data, I_mem when memcopy is complete, I_poll_timeout when there is no read response from the peripheral for a long time (peripheral is not responding with data when there is read request), I_mem_timeout when there is no response from the memory during read operation or write operation, I_poll_err when IAU 250 received slave error or decode error from the peripherals, and I_mem_err when the IAU 250 receives error response from the memory (read memory or write memory).

FIG. 5 is an example finite state machine (FSM) illustrating the manner in which IAU 250 may operate in an embodiment. The FSM is shown comprising states 510, 520, 530 and 540 for illustration. Same may be extended to deploy more functionality at the IAU 250. In that, state 510 depicts a reset state. In the reset state, the IAU 250 performs no actions (disabled). The state 520 is an enable state, in that the IAU is ready to perform the functionality and active. The state 530 is a memory copy state. In this state, the IAU 250 is performing the memory copy operation. The state 540 is a polling state. In this state, the IAU 250 polls the desired register for a value.

The IAU 250 is sent to the reset state 510 when the reset bit (in the IAU configuration register) is set to logic 0. The IAU 250 is sent to the enable state 520 when the reset bit is set to logical value 1. Similarly, the IAU 250 reaches the state 530 when opcode is 27 and returns to the state 520 when I_mem is set to 0 (interrupt I_Mem is detected and serviced by processor). Similarly, I_Poll would become Zero when I_Poll interrupt is serviced by the processor. IAU 250 reaches the state 540 when the opcode is 18 and return to the state 520 when I_Poll is 0. In this manner the IAU 250 may be configured to perform various operations in conjunction with the processor 205. In one embodiment, the opcode at 450-00 is written by the processor in the run time thereby maintaining the synchronization. The manner in which the IAU 250 may further enhance the performance of the SoC by virtue of being directly connected to the buses without NIC is further illustrated below.

In one embodiments, the IAU 250 may be employed for monitoring the activities on the bus 210A-210N. In that, IAU 250 operates with additional functionality of monitoring and reporting the bus activities. IAU 250 may access an additional memory unit (not shown) which can be memory connected to buses or its own internal memory without the use of NIC. In one embodiment, the IAU 250 monitors the signals on the buses. The operation of monitoring may be performed by not causing any load on the bus. For example, the IAU 250 may be configured to offer high impedance on the bus (like any signal measuring bus probes known in the art) and measure signals to-and-fro on the buses 210A-210N.

In one embodiment, the IAU, determine the instructions, from the measured signal sent by the NIC 220 and response received from the devices memory 230A-230D, general purpose I/O (GpIO) 240A-240F, IAU 250, peripherals 260, network links 270 and registers 280. For example, the signals measured may represent a request for data from a memory location, value from a register, protocol message for acknowledgement, write request, read request, etc. IAU may note the time taken by each device to respond to the instruction/command issued through NIC 220. The IAU may store the statistics of the response time measured, commands, responses, frequency of commands and corresponding responses, device active time, busy time, etc., in the memory specifically dedicated for recording the statistics (referred to as statistic memory).

Accordingly, the processor 205 may make use of the data/statistics stored in the statistics memory to issue commands, make use of the IAU 250 to enhance the performance. For example, when the statistics indicates that network link 270 response time (say x) is greater in during a first duration (say day time) compared to response time (say y) during the second duration (say night time) for same command, then processor 205 may instruct IAU 250 to monitor the response of network link 220 in the day and may directly monitor the response in the night time. Thus, processor may dynamically avoid waiting time when the expected waiting time is greater than or equal to y. While the example of dynamically enhancing the performance is provided with an example scenario, the same may be extended to more complex scenario without deviating from the motivation of the present disclosure.

While various embodiments of the present disclosure have been described above, it should be understood that they have been presented by way of example only, and not limitation. Thus, the breadth and scope of the present disclosure should not be limited by any of the above-discussed embodiments but should be defined only in accordance with the following claims and their equivalents.

What is claimed is:

1. A System on Chip (SoC) (101) comprising:
a set of processors (110) providing processing power in the SoC;
a network interconnect (NIC) (120) operative to couple the set of processors to a set of devices, the NIC comprising a first set of master nodes coupled to a set of buses;
a set of slave nodes dispersed over the set of devices (130), the set of slave nodes coupled to the set of buses thereby coupling the NIC and the set of devices for data transfer; and
an intelligent auxiliary unit (IAU) (150) comprising a second set of master nodes coupled to the set of buses (140),
wherein the IAU (150) is configured to perform a first set of operations on the set of devices (130) without accessing the NIC (120) otherwise required to be performed by the set of processors (110) through the NIC (120) thereby allowing the set of processors (110) to execute other operations.

2. The SoC of claim 1, wherein the set of devices further comprising first memory and a second memory and the first set of operation comprising transferring a first data from the first memory to second memory.

3. The SoC of claim 2, wherein the IAU further comprising a first memory storing a first set of instruction to perform the first set of operations.

4. The SoC of claim 3, wherein the IAU further comprising a set registers such that the value stored in the set of registers indicating one of the operations in the set of operation.

5. The SoC of claim 4, wherein the IAU further comprising a first slave node coupled to the NIC through one of a bus in the set of buses, in that, the set of processors writing a first value on the set of registers through NIC, the first value indicating a memory copy operation.

6. The SoC of claim 5, wherein the set of processors are of higher computing capability compared to that of the IAU.

7. The SoC of claim 6, wherein the set of processors is configured to perform more complex operations compared to the set of operation when IAU is performing the set of operation.
